(19) United States
(12) Patent Application Publication
(10) Pub. No.: US 2026/0185185 A1
(43) Pub. Date: Jul. 2, 2026

(54) SELECTIVE COBALT, MANGANESE AND NICKEL EXTRACTION FROM BATTERY RECYCLING LEACHATE SOLUTIONS

(71) Applicant: ASCEND ELEMENTS, INC., Westborough, MA (US)

(72) Inventors: Christophe Henri Robert Duhayon, Montreal (CA); Atefeh Azizitorghabeh, Kingston (CA)

(21) Appl. No.: 19/003,642

(22) Filed: Dec. 27, 2024

Related U.S. Application Data
(60) Provisional application No. 63/739,228, filed on Dec. 27, 2024.

(51) Int. Cl. C22B 3/00; C22B 3/32; C22B 3/38; C22B 7/00; C22B 47/00; H01M 10/54

(52) U.S. Cl. CPC C22B 23/0415; C22B 3/32; C22B 3/381; C22B 7/007; C22B 7/008; C22B 23/0453; C22B 47/00; H01M 10/54

(57) ABSTRACT

Methods of recovering a nickel, cobalt, and manganese salts are disclosed. The method includes removing one or more impurities from an acidic aqueous leach solution including cobalt, manganese, and nickel salts to produce a purified aqueous solution including the cobalt, manganese, nickel salts, and remaining impurity salts. The method includes extracting the purified aqueous solution in a first liquid-liquid extraction step using a first organic extractant to produce a first aqueous raffinate solution including the cobalt, manganese, and nickel salts and a first loaded organic solution including one or more of the remaining impurity salts from the purified aqueous solution. The method further includes extracting the cobalt, manganese, and nickel salts from the first aqueous raffinate solution in a second liquid-liquid extraction step using a second organic extractant to produce a second loaded organic solution including the cobalt, manganese and nickel salts and a second aqueous raffinate solution comprising one or more of the remaining impurity salts.

### CROSS-REFERENCE TO RELATED APPLICATIONS

This application claims priority under 35 U.S.C. § 119(e) to U.S. Provisional Patent Application Ser. No. 63/739,228, titled “SELECTIVE COBALT, MANGANESE, AND NICKEL SALT EXTRACTION FROM BATTERY RECYCLING LEACHATE SOLUTIONS,” filed Dec. 27, 2024, the entire contents of which is incorporated herein by reference for all purposes.

### BACKGROUND

Lithium-ion (Li-ion) batteries are a preferred chemistry for secondary, e.g., rechargeable, batteries in high discharge applications such as electrical vehicles (EVs) and power tools where electric motors are called upon for rapid acceleration. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metals such as lithium, nickel, manganese, cobalt, aluminum, iron, and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. Industry trends are moving towards a more nickel-rich chemistry, often preferring nickel, manganese, and cobalt (NMC) in molar ratios of N:M:C such as 5:3:2 (532), 6:2:2 (622), 8:1:1 (811), and 99:0.5/0/5 (9.5.5). It has been observed that as numerous electric vehicles attain the end of their service life, a potentially large recycling stream results from the charge material that might otherwise generate a harmful waste source.

### SUMMARY

A method disclosed herein recovers cobalt, manganese, and nickel salts, e.g., from a cathode material in a recycling stream of end-of-life batteries. One or more impurities from an acidic aqueous leach solution comprising cobalt, manganese, and nickel salts are at least partially removed to produce a purified aqueous solution comprising the cobalt, manganese, and nickel salts, along with remaining impurity salts. One or more of the remaining impurity salts from the acidic aqueous leach solution are extracted from the purified aqueous solution in a first liquid-liquid extraction step with a first organic extractant. The organic solution produced is a first loaded organic solution comprising the one or more of the remaining impurity salts. The aqueous raffinate solution from the first liquid-liquid extraction step comprises the cobalt, manganese, and nickel salts. The cobalt, manganese, and nickel salts may be extracted from the aqueous raffinate solution in a second liquid-liquid extraction step using a second organic extractant. The organic solution produced in the second liquid-liquid extraction step is a second loaded organic solution comprising the cobalt, manganese, and nickel salts, which can then be further processed, such as in additional liquid-liquid separations or related processes.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention. For purposes of clarity, not every component may be labeled in every drawing. In the drawings:

FIG. 1 illustrates a flow chart of a method for the recovery of a combination of a nickel salt, a cobalt salt, and a manganese salt, in accordance with an embodiment disclosed herein;

FIG. 2 illustrates the selectivity of metal salts in a first organic extractant solution comprising a dialkylphosphinic acid as a function of equilibrium pH;

FIG. 3 illustrates the selectivity of cobalt salts in a first organic extractant solution comprising a dialkylphosphinic acid as a function of equilibrium pH; and

FIG. 4 illustrates the selectivity of metal salts in a second organic extractant solution comprising an alkylcarboxylic acid as a function of equilibrium pH.

### DETAILED DESCRIPTION

This disclosure is directed to systems and methods for the recovery of cobalt, manganese, and nickel salts, e.g., from a nickel-containing, e.g., a nickel-rich, cathode material in a recycling stream of end-of-life batteries. Lithium-ion batteries contain valuable precious metals which would go to waste when the batteries are spent and discarded. With the rising use of lithium-ion batteries, the recovery of precious metals from spent lithium-ion batteries has become an important industry.

Typically, end-of-life lithium-ion batteries are dismantled, crushed, or shredded to form a granular mass of battery materials (including cathode materials, anode materials, current collectors, electrolytes, etc.), often referred to as “black mass” which is used for further recycling. Current lithium-ion battery recycling efforts are primarily focused on recovering the base metals cobalt and lithium from lithium cobalt oxide cathodes. However, there are many other types of cathode materials used in lithium-ion batteries. A significant portion of these cathode materials include other base metals such as nickel and manganese. Conventional recycling methods do not adequately handle the recycling of different types of lithium-ion battery cathode materials and fail to sufficiently address the extraction of these other metals. Many existing recovery processes have numerous extraction, scrubbing, and stripping stages, increasing costs and time to produce suitable materials for battery production.

Further, black mass, especially those derived collectively from different types of lithium-ion batteries, contains many types of impurities. Failing to effectively remove them adversely affects the purity of metals recovered by recycling. Present efforts of impurity removal involve numerous steps requiring many reactors and filters. Not only does this lengthen the entire recycling process and increase costs, but with each reactor or filter, valuable material is lost, resulting in a severe reduction in the amounts of base metals available for recovery.

Thus, there exists a need for a lithium-ion battery recycling process which can better handle the removal of impurities in black mass, especially that derived collectively from different types of lithium-ion batteries. There also exists an associated need to remove impurities in a more efficient way that requires less equipment and results in less reduction in the amounts of base metals available for recovery.

Depicted herein is an example method and approach for recycling batteries containing, inter alia, nickel, manganese, and cobalt. Lithium-ion batteries have been used for many applications and are becoming more and more important for electronic devices, electric vehicles, and energy storage systems. High nickel ternary or quaternary batteries are gathering more attention due the higher energy capacity and lower raw materials cost. The high nickel batteries often reach their end of life within 8-15 years, and they will comprise the bulk of spent lithium-ion batteries in the future. Front-end material recovery methods from black mass are becoming more important as a way to recycle spent batteries and as a source for battery cathode materials.

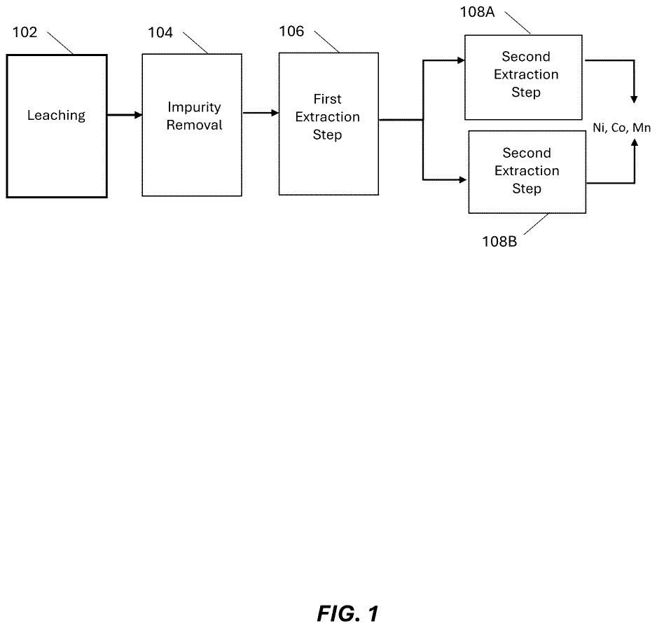

FIG. 1 is a flow diagram of an embodiment of a method for the recovery of a nickel salt, a cobalt salt, and a manganese salt from an acidic aqueous leach solution. With reference to FIG. 1, in recovery method 100, leaching 102 is performed on black mass to separate the recoverable materials from the black mass. The acidic aqueous leach solution is prepared by leaching metal salts from a granular black mass, such as one that results from crushed battery materials including cathode materials and anode materials, using an aqueous solution that includes an acid, such as sulfuric acid, hydrochloric acid, nitric acid, acetic acid, boric acid, oxalic acid, formic acid, or any other suitable organic or inorganic acid and may further include an optional oxidizing agent or reducing agent. In a specific embodiment, an aqueous acid solution such as sulfuric acid and water, optionally including hydrogen peroxide, and the black mass are combined to dissolve base metals present within the crushed battery materials into the aqueous phase.

The acidic aqueous leach solution includes the metal salts of interest, such as nickel, manganese, and cobalt salts, as well as numerous impurities that can impact the recovery of the metal salts of interest, e.g., salts of copper, zinc, iron (III), calcium, and magnesium. To remove some or all of these impurities, removal step 104 occurs in which insoluble compounds of the impurities are formed using a pH adjustment of the acidic aqueous leach solution. For example, an increase in the pH of the acidic aqueous leach solution using a water-soluble base, such as NaOH, NH₄OH, (NH₄)₂CO₃, or another water-soluble base, can facilitate precipitation of insoluble hydroxide compounds that can subsequently be removed, such as by filtration, to produce a purified aqueous solution comprising the cobalt, manganese, and nickel salts. In some embodiments, a pH of the purified aqueous solution is acidic, e.g., having a pH of from about 3 to 5.

With continued reference to FIG. 1, a method of recovering cobalt, manganese, and nickel salts includes first extraction step 106 configured to extract impurities remaining after impurity removal 104 from the purified aqueous solution. First extraction step 106 is a liquid-liquid extraction process using a solution of a first organic extractant that is substantially immiscible with the purified aqueous solution. When the purified aqueous solution and the first organic extractant solution are combined, a first aqueous raffinate solution including cobalt, manganese and nickel salts is produced. Impurities such as magnesium and calcium salts may also remain in the raffinate. A first loaded organic solution is also produced comprising any remaining impurity salts from the purified aqueous solution, such as copper, zinc, and iron (III).

Without wishing to be bound by any particular theory, organic extractants useful for liquid-liquid extractions disclosed herein are those having functionalities with affinity for the metal salts in the aqueous phase and with high selectivity for specific metal ions, depending on the pH of the aqueous phase. For example, the first organic extractant may be a dialkylphosphinic acid, e.g., R₁R₂PO₂H where R₁ and R₂ are alkyl groups. In some cases, the dialkylphosphinic acid is a thiophosphinic acid, e.g., R₁R₂P(═S)OH. As a non-limiting example, the first organic extractant may include di(2,4,4-trimethylpentyl)monothiophosphinic acid, i.e., CYANEX® 302 extractant. When used as part of the first organic extractant solution, the dialkylphosphinic acid may be present in a concentration of about 10% to about 20% w/w or v/v in the solution. The balance of the first organic extractant solution may include an organic diluent or one or more diluents in which the dialkylphosphinic acid is soluble. For example, a paraffinic diluent, such as Shell GTL solvent, may be used.

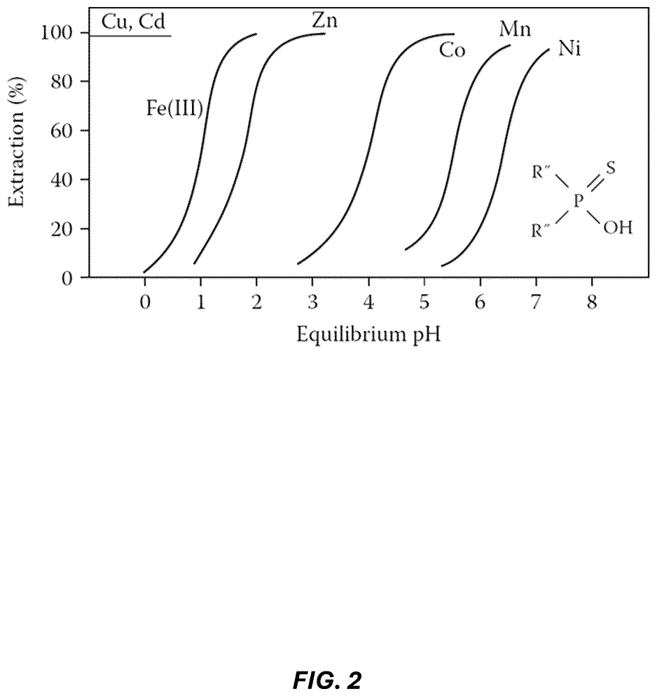

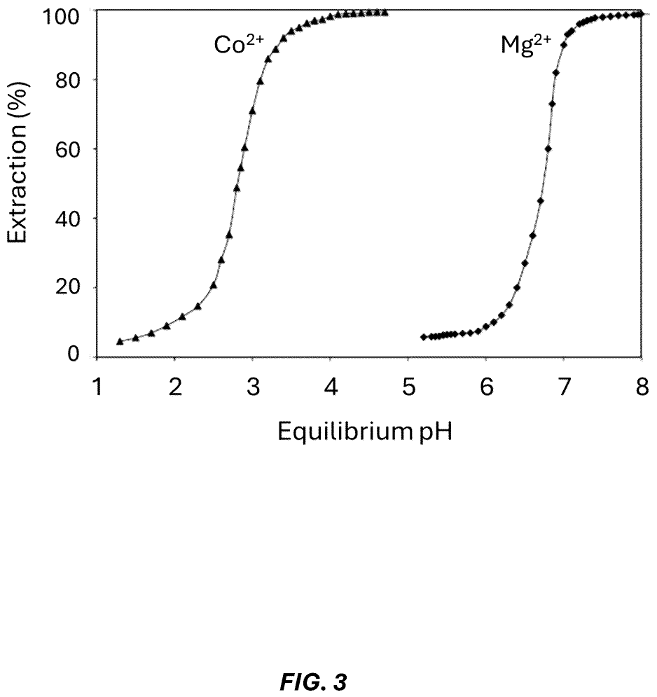

FIGS. 2 and 3 show the selectivity of various metal salts in a solution of a first organic extractant comprising a dialkylphosphinic acid, e.g., R₁R₂PO₂H where R₁ and R₂ are alkyl groups. Specifically, FIG. 2 shows the extraction isotherms at different pHs when the dialkylphosphinic acid is a thiophosphinic acid, e.g., R₁R₂P(═S)OH, and, in particular, di(2,4,4-trimethylpentyl)monothiophosphinic acid, i.e., CYANEX® 302, with FIG. 3 showing the extraction isotherms for cobalt and magnesium salts in CYANEX® 302. As shown in FIG. 2, cobalt, manganese, and nickel salts can be co-extracted within a narrow pH window, while impurity salts such as Zn and Fe(III) can be co-extracted within a different, much lower pH window. In some embodiments, therefore, during the first liquid-liquid extraction step, the purified aqueous solution has an equilibrium pH of less than 4, and, in specific embodiments, a pH of greater than 0, such as greater than 2. For example, the equilibrium pH during the first liquid-liquid extraction step is preferably from about 2 to about 4, such as from about 2.5 to about 3.5. Other specific ranges could be determined by one of ordinary skill in the art in view of the information illustrated in FIG. 2.

If necessary, the pH of the purified aqueous solution can be increased or decreased in order to achieve the desired equilibrium pH during the first liquid-liquid extraction step. For example, in some embodiments, a basic pH adjusting compound can be added to the purified aqueous solution to increase the pH. The pH adjusting compound can be a water-soluble base, such as NaOH, NH₄OH, (NH₄)₂CO₃, or another water-soluble base. In some embodiments, a water-soluble acid, such as a weak acid or a dilute acid, may be used to lower the pH. Suitable acids can be any of those described above relating to the acid of the acidic aqueous leach solution.

Once the target equilibrium pH of the purified aqueous solution is achieved, the first organic extractant and the purified aqueous solution can be combined in a fixed ratio of organic to aqueous phases, i.e., O:A ratio, to begin the first liquid-liquid extraction step. The specific ratio will depend on the concentration and type of metals to be extracted. Example O:A ratios include from about 1:1 to about 3:1, such as 2:1.

The efficiency of the first liquid-liquid extraction step can also be a function of the extraction temperature. In some embodiments, the first liquid-liquid extraction step is performed at a temperature from about 40° C. to about 60° C. In certain embodiments, the first liquid-liquid extraction step is performed at a temperature of about 50° C.

With continued reference to FIG. 1, first liquid-liquid extraction step 106 produces a first aqueous raffinate solution comprising the cobalt, manganese, and nickel salts and a first loaded organic solution comprising the remaining impurity salts from the purified aqueous solution. The metal salts in the first aqueous raffinate solution can be recovered using an additional liquid-liquid extraction step. For example, as disclosed herein, the first aqueous raffinate solution is used in second liquid-liquid extraction steps 108A or 108B using a solution of a second organic extractant. In FIG. 1, the first aqueous raffinate can be extracted using second liquid-liquid extraction step 108A or second liquid-liquid extraction step 108B where the second organic extractant in each is different.

In particular, in some embodiments of second liquid-liquid extraction step 108A, the second organic extractant may be a dialkylphosphinic acid, e.g., R₁R₂PO₂H where R₁ and R₂ are alkyl groups. In some cases, the dialkylphosphinic acid is a thiophosphinic acid, e.g., R₁R₂P(═S)OH. As a non-limiting example, the second organic extractant for step 108A is di(2,4,4-trimethylpentyl)monothiophosphinic acid, i.e., CYANEX® 302 extractant.

In some embodiments of second liquid-liquid extraction step 108B, the second organic extractant may be an alkylcarboxylic acid, e.g., iso-carboxylic acids, neo-carboxylic acids, sec-carboxylic acids, and tert-carboxylic acids. As a non-limiting example, the second organic extractant may be neo-decanoic acid, i.e., VERSATIC™ acid 10 extractant. As it pertains to the present disclosure, when used as part of the second organic extractant solution, the alkylcarboxylic acid may be present in a concentration of about 30% to about 50% w/w or v/v in solution. The balance of the second organic extractant solution may include an organic diluent or one or more diluents in which the alkylcarboxylic acid is soluble. For example, a paraffinic diluent may be used.

When the second organic extractant solution includes a dialkylphosphinic acid, the equilibrium pH for the second liquid-liquid extraction step is different than the pH when this organic extractant is used in first extraction step 106. Specifically, during the second liquid-liquid extraction step with a dialkylphosphinic acid as the second organic extractant, the first aqueous raffinate solution has an equilibrium pH of less than 7 and, in specific embodiments, a pH of greater than 0, such as greater than 2. For example, the equilibrium pH during the second liquid-liquid extraction step is preferably from about 5 to about 7.

In some embodiments, when the second organic extractant solution includes an alkylcarboxylic acid, the equilibrium pH for the second liquid-liquid extraction step can be achieved by saponification of the alkylcarboxylic acid. As a non-limiting example, the water-soluble base, e.g., NaOH, NH₄OH, (NH₄)₂CO₃, or another water-soluble base, alone or in combination, can achieve a degree of saponification of the alkylcarboxylic acid of about 25-35%. To achieve this level of saponification of the alkylcarboxylic acid in the second organic extractant solution, the concentration of the water-soluble base can be, for example, about 50% w/w.

Once the target equilibrium pH has been achieved, the second organic extractant solution and the first aqueous raffinate solution can be combined in a fixed ratio of organic to aqueous, i.e., O:A ratio, to begin the second liquid-liquid extraction step. The specific ratio will depend on the concentration and type of metals to be extracted. Example O:A ratios include from about 1:1 to about 3:1, such as 2:1.

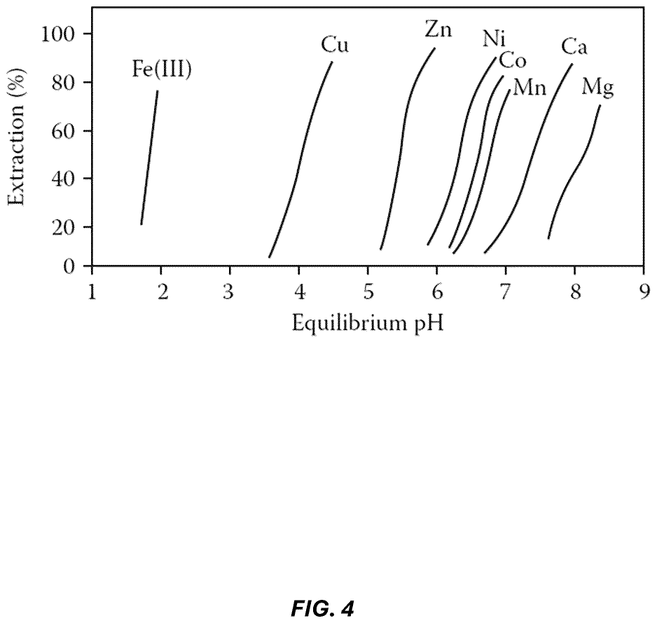

As illustrated in FIG. 4, the selectivity of various metal salts in a solution of a second organic extractant comprising an alkylcarboxylic acid is a function of the equilibrium pH of the extraction solution. In FIG. 4, nickel, cobalt, and manganese salts can be extracted within a pH window that is distinct from impurities such as Fe (III) and Cu salts as well as within a pH window that is distinct from impurities such as Ca and Mg salts. In some embodiments, during the second liquid-liquid extraction step, the first aqueous raffinate solution has an equilibrium pH of less than 7 and, in specific embodiments, a pH of greater than 0, such as greater than 2. For example, the equilibrium pH during the second liquid-liquid extraction step is preferably from about 3 to about 7. In a particular embodiment, this pH range produces a second raffinate containing Ca and Mg salts and a second loaded organic solution comprising the nickel, cobalt, and manganese salts. As discussed herein, if necessary, to increase the pH of the first aqueous raffinate solution to achieve the equilibrium pH during the second liquid-liquid extraction step, a basic pH adjusting compound or an adjusting compound that has an acidic pH close to neutral can be added to the aqueous raffinate solution. For example, the pH adjusting compound can be a water-soluble base, such as NaOH, NH₄OH, (NH₄)₂CO₃, or another water-soluble base.

As noted above, the first loaded organic solution from first extraction step 106 comprises any remaining impurity salts from the purified aqueous solution, such as copper, zinc, and iron (III). Also, the second raffinate solution from second extraction steps 108A and 108B also comprises impurity salts, such as calcium and magnesium salts. These solutions with impurity salts can either be disposed of as waste or further processed to isolate and recover the solid salts from the solutions. The second loaded organic solution, comprising nickel, cobalt, and manganese salts, can be further processed to isolate these salts, separately or combined, for use in the production of cathode material precursors. In particular, the nickel salts may be isolated from the cobalt and magnesium salts, using a process as described in co-pending U.S. application Ser. No. 18/792,977, filed Aug. 1, 2024, which is incorporated in its entirety by reference herein.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated that various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of recovering cobalt, manganese, and nickel salts, comprising:
removing one or more impurities from an acidic aqueous leach solution comprising cobalt, manganese, and nickel salts to produce a purified aqueous solution comprising the cobalt, manganese, nickel salts, and remaining impurity salts;
extracting the purified aqueous solution in a first liquid-liquid extraction step using a solution comprising a first organic extractant to produce a first aqueous raffinate solution comprising the cobalt, manganese, and nickel salts and a first loaded organic solution comprising one or more of the remaining impurity salts from the purified aqueous solution; and
extracting the cobalt, manganese, and nickel salts from the first aqueous raffinate solution in a second liquid-liquid extraction step using a solution comprising a second organic extractant to produce a second loaded organic solution comprising the cobalt, manganese, and nickel salts and a second aqueous raffinate solution comprising one or more of the remaining impurity salts.

2. The method of claim 1, wherein the acidic aqueous leach solution is prepared by leaching metal salts from a granular mass of crushed battery materials including cathode materials and anode materials with an aqueous solution comprising at least one acid.

3. The method of claim 2, wherein the aqueous solution further comprises hydrogen peroxide.

4. The method of claim 1, wherein removing the one or more impurities from the acidic aqueous leach solution comprises precipitation by pH adjustment.

5. The method of claim 1, wherein the first organic extractant is a dialkylphosphinic acid.

6. The method of claim 5, wherein the dialkylphosphinic acid is a thiophosphinic acid.

7. The method of claim 5, wherein the dialkylphosphinic acid is di(2,4,4-trimethylpentyl)monothiophosphinic acid.

8. The method of claim 5, wherein the dialkylphosphinic acid is dissolved in an organic diluent to a concentration of about 10% to about 20%.

9. The method of claim 1, wherein, during the first liquid-liquid extraction step, the purified aqueous solution has an equilibrium pH of less than 4.

10. The method of claim 7, wherein the equilibrium pH is from about 2.5 and about 3.5.

11. The method of claim 7, wherein the equilibrium pH is achieved by increasing the pH of the purified aqueous solution using a water-soluble base.

12. The method of claim 1, wherein the first liquid-liquid extraction step occurs at a temperature of from about 40° C. to about 60° C.

13. The method of claim 1, wherein the second organic extractant is an alkylcarboxylic acid.

14. The method of claim 13, wherein, during the second liquid-liquid extraction step, the first aqueous raffinate solution has an equilibrium pH of from about 3 to 7.

15. The method of claim 14, wherein the equilibrium pH is achieved by increasing the pH of the first aqueous raffinate solution using a water-soluble base.

16. The method of claim 1, wherein the second organic extractant is a dialkylphosphinic acid.

17. The method of claim 16, wherein the dialkylphosphinic acid is a thiophosphinic acid.

18. The method of claim 16, wherein the dialkylphosphinic acid is di(2,4,4-trimethylpentyl)monothiophosphinic acid.

19. The method of claim 16, wherein, during the second liquid-liquid extraction step, the first aqueous raffinate solution has an equilibrium pH of from about 5 to 7.

20. The method of claim 16, wherein the equilibrium pH is achieved by increasing the pH of the aqueous raffinate solution using a water-soluble base.
